(19) United States
(12) Patent Application Publication
(10) Pub. No.: US 2025/0272574 A1
(43) Pub. Date: Aug. 28, 2025

(54) OFFLINE MULTI-VENDOR TRAINING FOR CROSS-NODE MACHINE LEARNING

(71) Applicant: QUALCOMM Incorporated, San Diego, CA (US)

(72) Inventors: June NAMGOONG, San Diego, CA (US); Taesang YOO, San Diego, CA (US); Chenxi HAO, Beijing (CN); Jay Kumar SUNDARARAJAN, San Diego, CA (US); Joseph Binamira SORIAGA, San Diego, CA (US); Yiyue CHEN, San Diego, CA (US)

(21) Appl. No.: 18/859,377

(22) PCT Filed: Jul. 8, 2022
(86) PCT No.: PCT/CN2022/104533

§ 371 Date: Oct. 23, 2024

(51) Int. Cl. G06N 3/098; G06N 3/0455

(52) U.S. Cl. CPC G06N 3/098; G06N 3/0455

(57) ABSTRACT

Various aspects of the present disclosure generally relate to wireless communication. In some aspects, a first server may transmit encoder training data regarding an encoder to a set of second servers associated with training a set of decoders and with a set of vendors, wherein the first server is associated with a particular vendor of the set of vendors. The first server may receive, from the set of second servers and based at least in part on transmitting the encoder training data, decoder training data associated with a configuration of the encoder. Numerous other aspects are described.

### FIELD OF THE DISCLOSURE

Aspects of the present disclosure generally relate to wireless communication and to techniques and apparatuses for offline multi-vendor training for cross-node machine learning.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method performed by a first server. The method may include transmitting encoder training data regarding an encoder to a set of second servers associated with training a set of decoders and with a set of vendors, wherein the first server is associated with a particular vendor of the set of vendors. The method may include receiving, from the set of second servers and based at least in part on transmitting the encoder training data, decoder training data associated with a configuration of the encoder.

Some aspects described herein relate to a method performed by a second server. The method may include receiving, from a plurality of first servers associated with a plurality of encoders and a set of vendors, encoder training data regarding the plurality of encoders, wherein the second server is associated with a particular vendor of the set of vendors. The method may include transmitting, to the plurality of first servers and based at least in part on receiving the encoder training data, decoder training data, of a decoder, associated with a configuration of the plurality of encoders.

Some aspects described herein relate to a first server. The first server may include a memory and one or more processors coupled to the memory. The one or more processors may be configured to transmit encoder training data regarding an encoder to a set of second servers associated with training a set of decoders and with a set of vendors, wherein the first server is associated with a particular vendor of the set of vendors. The one or more processors may be configured to receive, from the set of second servers and based at least in part on transmitting the encoder training data, decoder training data associated with a configuration of the encoder.

Some aspects described herein relate to a second server. The second server may include a memory and one or more processors coupled to the memory. The one or more processors may be configured to receive, from a plurality of first servers associated with a plurality of encoders and a set of vendors, encoder training data regarding the plurality of encoders, wherein the second server is associated with a particular vendor of the set of vendors. The one or more processors may be configured to transmit, to the plurality of first servers and based at least in part on receiving the encoder training data, decoder training data, of a decoder, associated with a configuration of the plurality of encoders.

Some aspects described herein relate to a non-transitory computer-readable medium that stores a set of instructions by a first server. The set of instructions, when executed by one or more processors of the first server, may cause the first server to transmit encoder training data regarding an encoder to a set of second servers associated with training a set of decoders and with a set of vendors, wherein the first server is associated with a particular vendor of the set of vendors. The set of instructions, when executed by one or more processors of the first server, may cause the first server to receive, from the set of second servers and based at least in part on transmitting the encoder training data, decoder training data associated with a configuration of the encoder.

Some aspects described herein relate to a non-transitory computer-readable medium that stores a set of instructions by a second server. The set of instructions, when executed by one or more processors of the second server, may cause the second server to receive, from a plurality of first servers associated with a plurality of encoders and a set of vendors, encoder training data regarding the plurality of encoders, wherein the second server is associated with a particular vendor of the set of vendors. The set of instructions, when executed by one or more processors of the second server, may cause the second server to transmit, to the plurality of first servers and based at least in part on receiving the encoder training data, decoder training data, of a decoder, associated with a configuration of the plurality of encoders.

Some aspects described herein relate to a first apparatus. The first apparatus may include means for transmitting encoder training data regarding an encoder to a set of second apparatuses associated with training a set of decoders and with a set of vendors, wherein the first apparatus is associated with a particular vendor of the set of vendors. The first apparatus may include means for receiving, from the set of second apparatuses and based at least in part on transmitting the encoder training data, decoder training data associated with a configuration of the encoder.

Some aspects described herein relate to a second apparatus. The second apparatus may include means for receiving, from a plurality of first apparatuses associated with a plurality of encoders and a set of vendors, encoder training data regarding the plurality of encoders, wherein the second apparatus is associated with a particular vendor of the set of vendors. The second apparatus may include means for transmitting, to the plurality of first apparatuses and based at least in part on receiving the encoder training data, decoder training data, of a decoder, associated with a configuration of the plurality of encoders.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical channels and reference signals in a wireless network, in accordance with the present disclosure.

FIGS. 5A-5D are diagrams illustrating an example associated with offline multi-vendor training for cross-node machine learning, in accordance with the present disclosure.

FIG. 6 is a diagram illustrating an example process performed, for example, by a first server, in accordance with the present disclosure.

FIG. 7 is a diagram illustrating an example process performed, for example, by a second server, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

FIG. 11 is a diagram illustrating an example of training and using a machine learning model in connection with offline multi-vendor training for cross-node machine learning, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

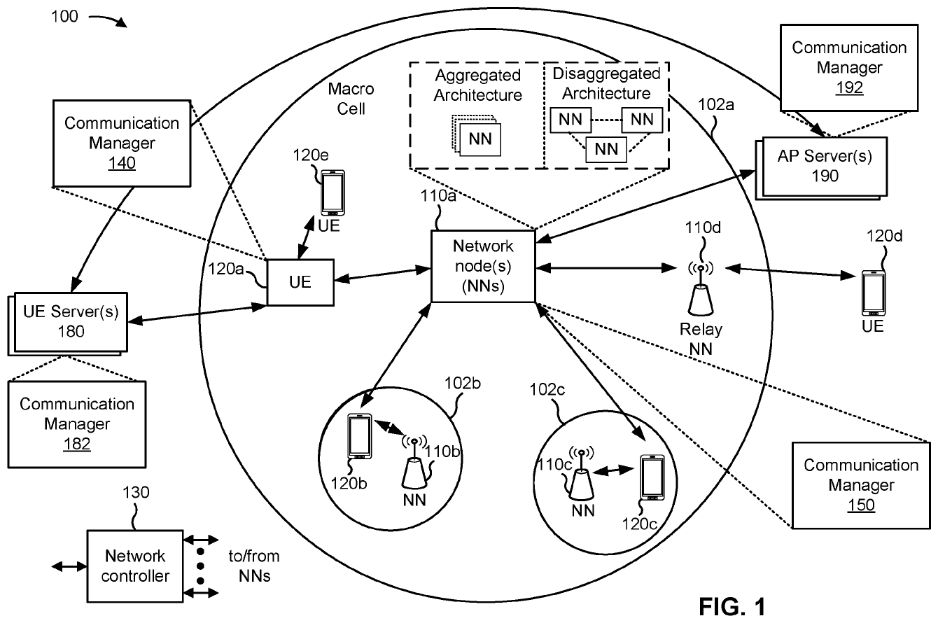

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an encoder trained by a UE server 180; may use the encoder to encode and/or compress channel state feedback (CSF); and may transmit the encoded and/or compressed CSF to the network node 110 for processing. Additionally, or alternatively, the communication manager 140 may perform one or more other operations described herein.

In some aspects, the network node 110 may include a communication manager 150. As described in more detail elsewhere herein, the communication manager 150 may receive a decoder from an access point (AP) server 190; may receive encoded and/or compressed CSF from the UE 120; may process the encoded and/or compressed CSF to decode and/or decompress and recover CSF; and may configure communication on a channel based at least in part on recovering the CSF. Additionally, or alternatively, the communication manager 150 may perform one or more other operations described herein.

In some aspects, a first server (e.g., the UE server 180) may include a communication manager 182. As described in more detail elsewhere herein, the communication manager 182 may transmit encoder training data regarding an encoder to a set of second servers associated with training a set of decoders and with a set of vendors, wherein the first server is associated with a particular vendor of the set of vendors; and receive, from the set of second servers and based at least in part on transmitting the encoder training data, decoder training data associated with a configuration of the encoder. Additionally, or alternatively, the communication manager 182 may perform one or more other operations described herein.

In some aspects, a second server (e.g., the AP server 190) may include a communication manager 192. As described in more detail elsewhere herein, the communication manager 192 may receive, from a plurality of first servers associated with a plurality of encoders and a set of vendors, encoder training data regarding the plurality of encoders, wherein the second server is associated with a particular vendor of the set of vendors; and transmit, to the plurality of first servers and based at least in part on receiving the encoder training data, decoder training data, of a decoder, associated with a configuration of the plurality of encoders. Additionally, or alternatively, the communication manager 192 may perform one or more other operations described herein.

As indicated above, FIG. 1 is provided as an example. Other examples may differ from what is described with regard to FIG. 1.

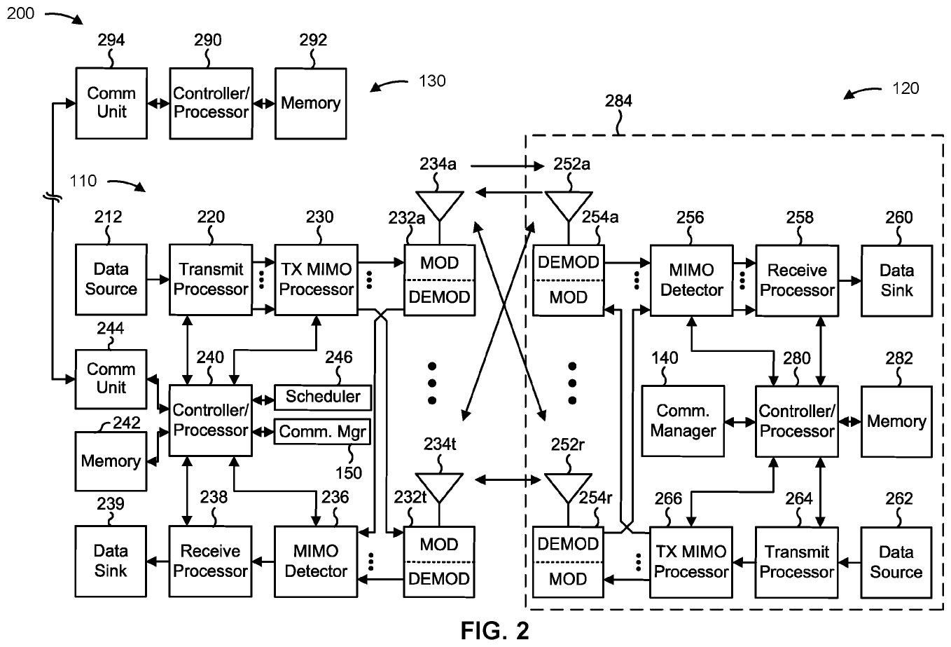

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

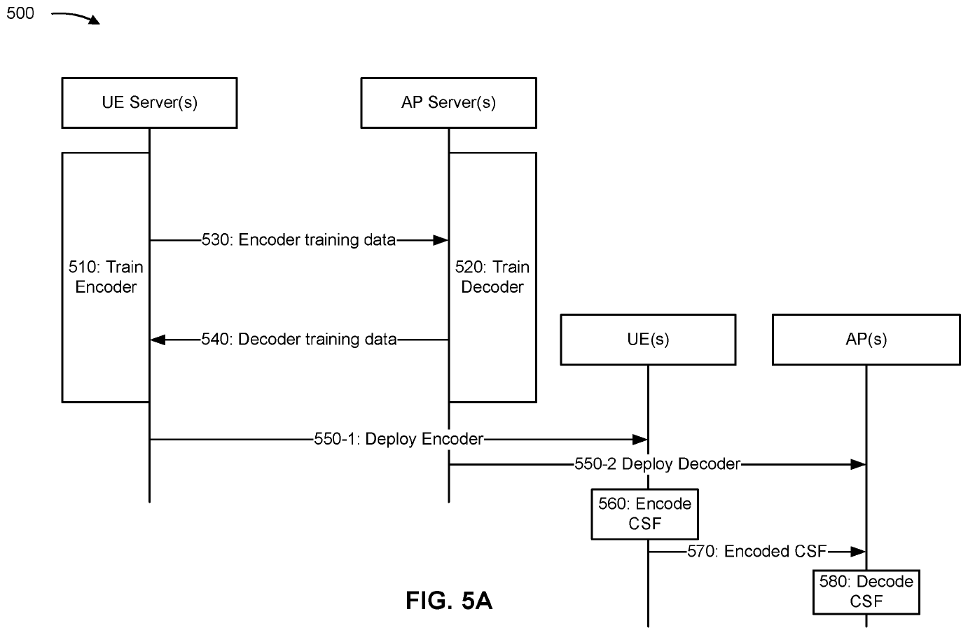

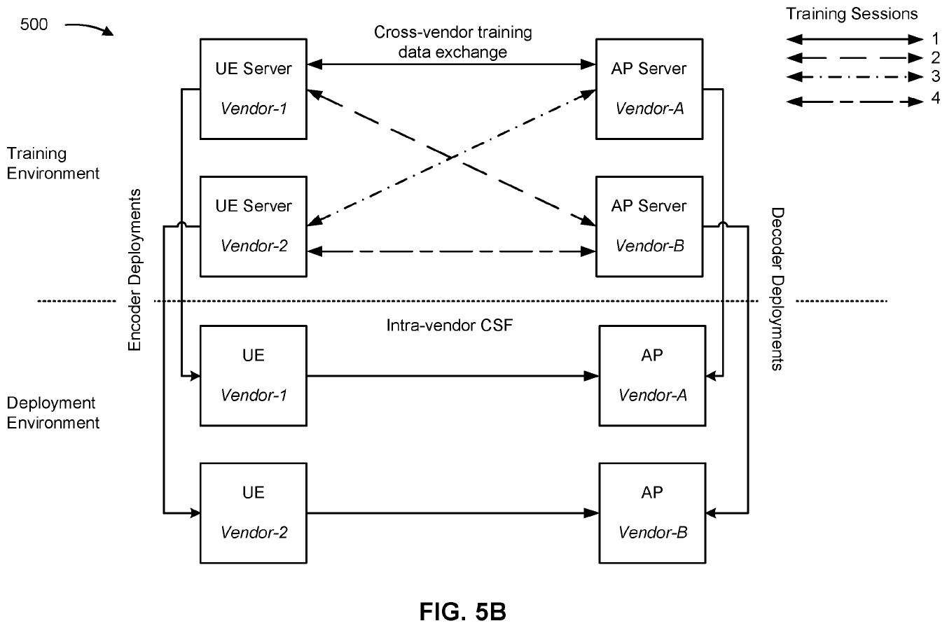

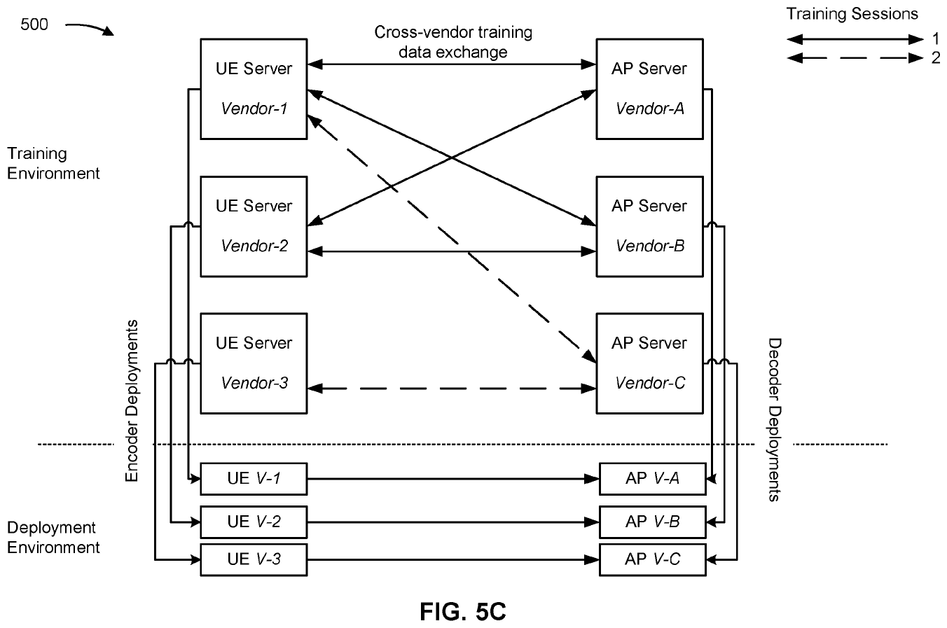

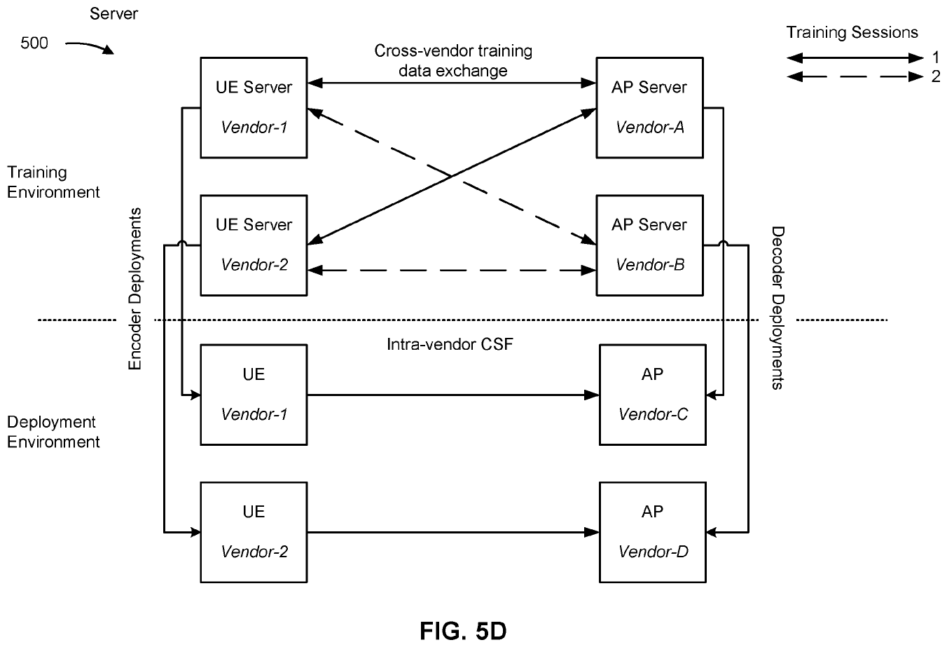

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A-11).

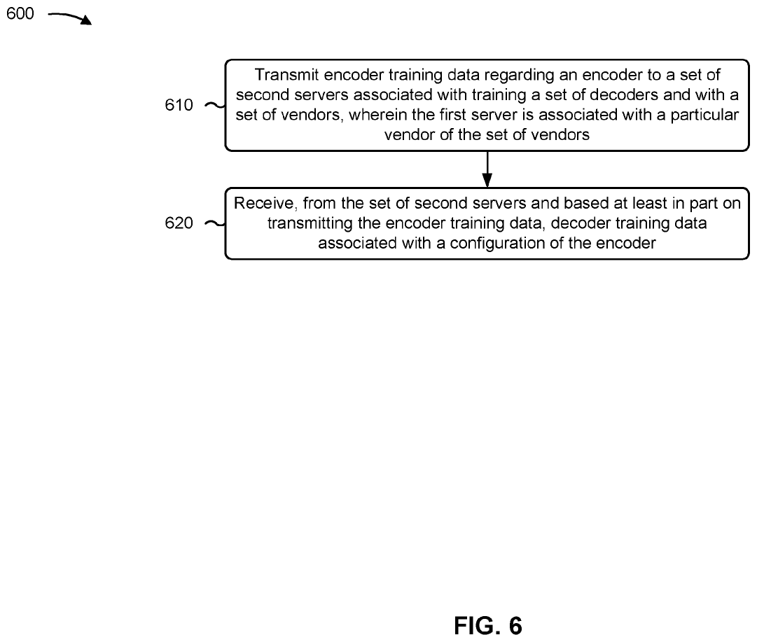

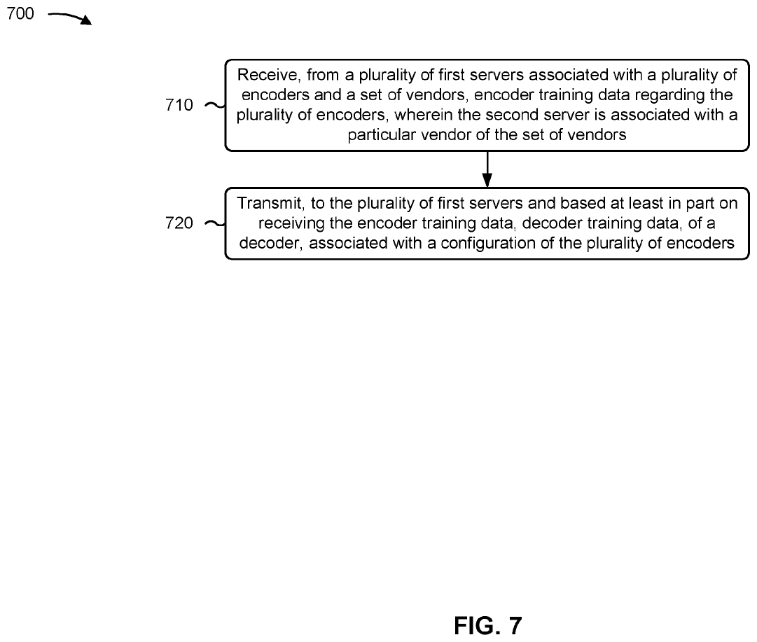

The controller/processor 240 of the network node 110, the controller/processor 280 of the UE 120, and/or any other component(s) of FIG. 2 may perform one or more techniques associated with offline multi-vendor training for cross-node machine learning, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE 120 includes means for receiving an encoder; means for encoding CSF using the encoder; and/or means for transmitting the encoded CSF to a network node 110. In some aspects, the means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node 110 includes means for receiving a decoder, means for receiving encoded CSF; and/or means for decoding the CSF using the decoder. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a first server (e.g., a UE server 180) includes means for transmitting encoder training data regarding an encoder to a set of second servers associated with training a set of decoders and with a set of vendors, wherein the first server is associated with a particular vendor of the set of vendors; and/or means for receiving, from the set of second servers and based at least in part on transmitting the encoder training data, decoder training data associated with a configuration of the encoder. In some aspects, the means for the first server to perform operations described herein may include, for example, one or more of communication manager 182, an input component, an output component, a processor, or a memory.

In some aspects, a second server (e.g., an AP server 190) includes means for receiving, from a plurality of first servers associated with a plurality of encoders and a set of vendors, encoder training data regarding the plurality of encoders, wherein the second server is associated with a particular vendor of the set of vendors; and/or means for transmitting, to the plurality of first servers and based at least in part on receiving the encoder training data, decoder training data, of a decoder, associated with a configuration of the plurality of encoders. In some aspects, the means for the second server to perform operations described herein may include, for example, one or more of communication manager 192, an input component, an output component, a processor, or a memory.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

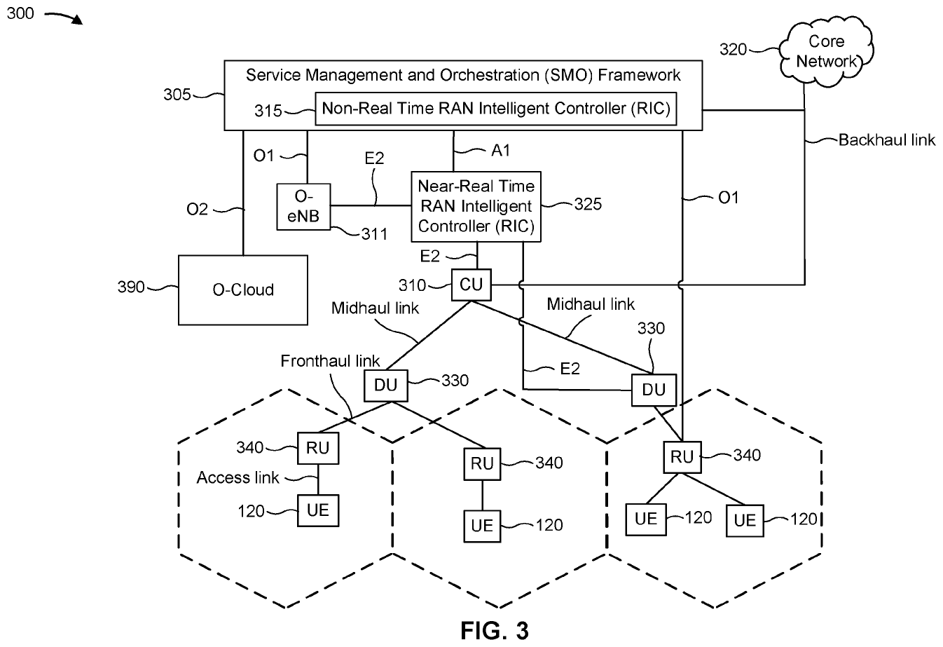

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

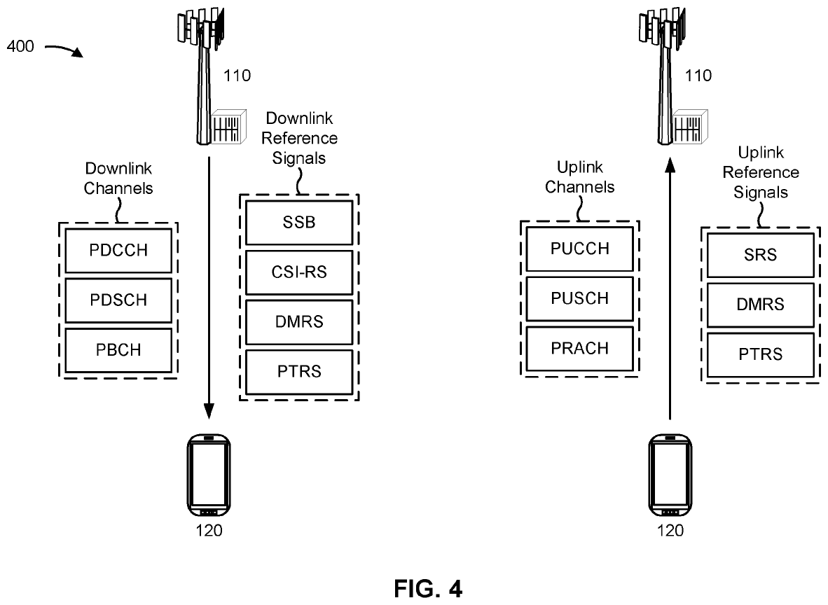

FIG. 4 is a diagram illustrating an example 400 of physical channels and reference signals in a wireless network, in accordance with the present disclosure. As shown in FIG. 4, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

In some communications systems, a UE may perform one or more measurements of a channel condition and may generate channel state feedback (CSF), which may include precoding vectors, to transmit to a network node. The network node may use the CSF to configure communications on the channel. For example, the network node may select a precoder, schedule communications, select a modulation and coding scheme, select a beam, or select a quasi-co-location (QCL) parameter for communications on a channel. However, CSF may have a relatively high level of overhead on a channel. Accordingly, the UE may compress the CSF before transmission to the network node. For example, the UE may use an encoder to process the CSF and generate compressed CSF, which is transmitted to the network node. The network node receives the compressed CSF and may use a decoder to process the compressed CSF to recover the CSF. Although some aspects are described herein in terms of CSF and communications between a UE and a network node, encoders and decoders may be used for other information being conveyed between a transmitter device and a receiver device.

Servers may train encoders and decoders that are used to compress and decompress, for example, precoding vectors included in CSF to reduce overhead associated with CSF reporting. For example, a first server may train an encoder and a decoder, provide a training set for the decoder to a second server, and the second server may train the decoder using the training set. This procedure may be offline training, which may include using one or more generated training sets processed on one or more servers, rather than training occurring on the UE and network node to which the encoder and decoder will be deployed, respectively.

Each vendor that manufacturers and distributes UEs or access points (APs) (e.g., which may correspond to network nodes described herein) may use a separate set of servers to participate in offline training. In other words, a first UE vendor and a first AP vendor may train a first encoder and decoder using one or more first data sets, and a second UE vendor and a second AP vendor may training a second encoder and decoder, separately, using one or more second data sets. The UE vendors and AP vendors may be the same or different groups of vendors. However, performing separate training for each possible pair of a UE vendor and a AP vendor may result in separate training for each encoder and decoder, which may result in an excessive quantity of training sessions and excessive quantity of encoder models and decoder models.

Some aspects described herein enable multi-vendor training for cross-node machine learning. For example, first server associated with first vendors may communicate with second servers associated with second vendors to collectively train one or more encoders and decoders. In this way, machine learning training can use a reduced number of training sessions than would be needed in separate training for each pair of vendors, thereby reducing a utilization of computing resources to perform training, while reducing the number of encoder models and decoder models. Moreover, combining training from multiple vendors may result in improved encoders and decoders, which may enable better compression and decompression of, for example, CSF, thereby improving communications performance on networks that use the encoders and decoders.

FIGS. 5A-5D are diagrams illustrating an example 500 associated with offline multi-vendor training for cross-node machine learning, in accordance with the present disclosure. As shown in FIG. 5A, example 500 includes communication between a set of UE servers (e.g., UE servers 180), a set of access point (AP) servers (e.g., AP servers 190), a set of UEs (e.g., UEs 120), and a set of APs (e.g., network nodes 110).

As further shown in FIG. 5A, and by reference numbers 510 and 520, the UE servers and the AP servers may train encoders and decoders, respectively. An encoder may include a neural network or other machine learning model for compressing CSF. Similarly, a decoder may include a neural network or other machine learning model for decompressing compressed CSF. For example, a UE server associated with a first vendor may train an encoder and an AP server associated with the first vendor may train a corresponding decoder. Similarly, a UE server associated with a second vendor may train an encoder and an AP server associated with the first vendor may train a corresponding decoder.

In some aspects, the UE servers and the AP servers may train encoders and decoders. For example, a UE server may train an encoder and communicate the encoder training set to a corresponding AP server for training of a decoder of the AP server for deployment to an AP associated with the AP server. As shown by reference numbers 530 and 540, the UE servers and the AP servers may communicate to exchange encoder training data and decoder training data.

In a first configuration, the UE servers and the AP servers may perform 1:1 split learning to train the encoders and decoders using the encoder training data and decoder training data. As shown in FIG. 5B, in 1:1 split learning, a first UE server and a first AP server may be associated with a first UE vendor (Vendor-1) and a first AP vendor (Vendor-A), and a second UE server, and a second AP server may be associated with a second UE vendor and a second AP vendor. Although Vendor-1 and Vendor-A may be described as different vendors, Vendor-1 and Vendor-A may be the same vendor or may be different vendors that are paired with each other for UE/AP encoder/decoder training. In other words, the first UE and the first AP vendor may both be associated with a particular vendor when Vendor-1 and Vendor-A are the same vendor or when Vendor-1 and Vendor-A are paired (in this case, the first UE is associated with both Vendor-1 and Vendor-A and the first AP is associated with both Vendor-A and Vendor-1, which may or may not be the same vendor). The first UE server may provide ground truth information and activation information to the first AP server and to the second AP server via a first training session and a second training session, and may receive gradient information from the first AP server and the second AP server via the first training session and the second training session. Similarly, the second UE server may provide ground truth information and activation information to the first AP server and to the second AP server via a third training session and a fourth training session, and may receive gradient information from the first AP server and the second AP server via the third training session and the fourth training session. In this case, each UE server and/or each AP server may provide an encoder and/or a decoder to a respective set of UEs or APs associated with the UE server and/or the AP server. For example, the first UE server may provide an encoder to a first UE associated with the first vendor or the second UE server may provide an encoder to a second UE associated with the second vendor, among other examples.

In a second configuration, the UE servers and the AP servers may perform many-to-many split learning to train encoders and decoders using the encoder training data and the decoder training data. As shown in FIG. 5C, in many-to-many split learning, the first UE server and the second UE server provide ground truth information and activation information to (and receive gradient information from) the first AP server and the second AP server via a first training session. Similarly, the first UE server and a third UE server provide ground truth information and activation information to (and receive gradient information from a third AP server via a second training session. In this case, although multiple vendors' servers may be involved in training of each encoder or decoder, there need not be complete overlap (e.g., a second UE server associated with the second UE vendor may not have a training session with the third AP server associated with the third AP vendor).

In some aspects, to allow joint training of encoders and decoders, each UE server may provide ground truth information to each AP server. The ground truth information may include, for example, information identifying the training set that a UE server could use to train a decoder corresponding to an encoder of the UE server. Additionally, or alternatively, the encoder training data and decoder training data may include gradient information and activation information. For example, a UE server may transmit outputs from a last layer of an encoder to each AP server as activation information. Each AP server may input the received activation information to a corresponding decoder, and may determine a loss function value using the ground truth information. Each AP server may use information determined from the loss function to back-propagate gradients to the input to the decoder. Additionally, or alternatively, each AP server may transmit the gradients to each UE server, and the UE servers may back-propagate the gradients to the input to the encoders. In this case, different AP servers may not share decoders with each other (and different UE servers may not share encoders with each other), but may share data from which to train the decoders (or encoders).

In a third configuration, the UE servers and the AP servers may perform many-to-one federated learning to train encoders and decoders using the encoder training data and the decoder training data. As shown in FIG. 5C, in many-to-one federated learning, the first UE server and the second UE server may provide gradient information and/or model weights for the first decoder to the first AP server via a first training session, and gradient information and/or model weights for the second decoder to the second AP server via a second training session. The first AP server and/or the second AP server may generate a global model and provide the global model to the UE servers (as a local copy). In this case, training is performed on the UE servers and the AP servers aggregate training results (e.g., weights or gradients) from the UE server to update a global model. A UE server may train both a UE-specific model (an encoder) and a local copy of the global model (a decoder).

As shown by reference numbers 550-1 and 550-2, the UE servers and the AP servers may deploy encoders and decoders to the UEs and the APs, respectively. For example, a first vendor's UE server may deploy encoders to the first UE vendor's UEs and a second UE vendor's UE server may deploy encoders to the second UE vendor's UEs. Similarly, decoders may be deployed on a vendor-specific basis. As shown by reference numbers 560, 570, and 580, an inference procedure may occur among the UEs and APs. In an inference procedure, a UE may determine CSF, compress the CSF using an encoder, and transmit compressed CSF to an AP, and the AP may attempt to decompress the compressed CSF using a decoder that corresponds to the encoder.

As indicated above, FIGS. 5A-5D are provided as an example. Other examples may differ from what is described with respect to FIGS. 5A-5D.

FIG. 6 is a diagram illustrating an example process 600 performed, for example, by a first server, in accordance with the present disclosure. Example process 600 is an example where the first server (e.g., UE server 180) performs operations associated with offline multi-vendor training for cross-node machine learning.

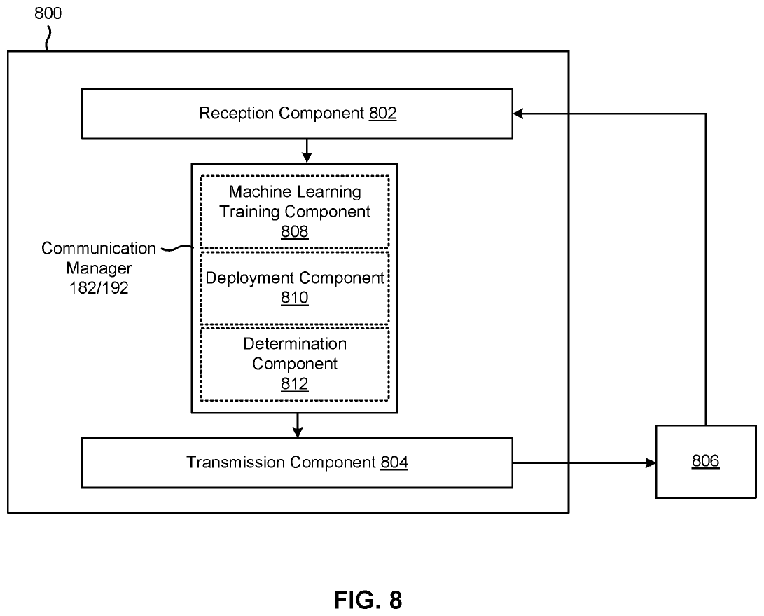

As shown in FIG. 6, in some aspects, process 600 may include transmitting encoder training data regarding an encoder to a set of second servers associated with training a set of decoders and with a set of vendors, wherein the first server is associated with a particular vendor of the set of vendors (block 610). For example, the first server (e.g., using communication manager 182 and/or transmission component 804, depicted in FIG. 8) may transmit encoder training data regarding an encoder to a set of second servers associated with training a set of decoders and with a set of vendors, wherein the first server is associated with a particular vendor of the set of vendors, as described above.

As further shown in FIG. 6, in some aspects, process 600 may include receiving, from the set of second servers and based at least in part on transmitting the encoder training data, decoder training data associated with a configuration of the encoder (block 620). For example, the first server (e.g., using communication manager 182 and/or reception component 802, depicted in FIG. 8) may receive, from the set of second servers and based at least in part on transmitting the encoder training data, decoder training data associated with a configuration of the encoder, as described above.

Process 600 may include additional aspects, such as any single aspect or any combination of aspects described below and/or in connection with one or more other processes described elsewhere herein.

In a first aspect, the encoder training data includes at least one of ground truth data, activation data, or gradient data.

In a second aspect, alone or in combination with the first aspect, the decoder training data includes gradient data.

In a third aspect, alone or in combination with one or more of the first and second aspects, process 600 includes training the encoder using a training set for the encoder, and transmitting the encoder training data comprises transmitting information identifying one or more outputs from the training of the encoder.

In a fourth aspect, alone or in combination with one or more of the first through third aspects, process 600 includes training the encoder using the decoder training data.

In a fifth aspect, alone or in combination with one or more of the first through fourth aspects, process 600 includes deploying the encoder to at least one UE associated with the particular vendor.

In a sixth aspect, alone or in combination with one or more of the first through fifth aspects, the at least one UE, to which the encoder is deployed, is associated with at least one access point, associated with the particular vendor, to which a decoder, of the set of decoders, is deployed.

In a seventh aspect, alone or in combination with one or more of the first through sixth aspects, other decoders, of the set of decoders, are deployed to one or more other access points associated with one or more other UEs, to which other encoders, trained by one or more other first servers, are deployed, wherein the one or more other access points and the one or more other UEs are associated with one or more vendors, other than the particular vendor, of the set of vendors.

In an eighth aspect, alone or in combination with one or more of the first through seventh aspects, the set of decoders includes a single global decoder corresponding to a plurality of encoders and associated with the set of vendors, wherein the plurality of encoders includes the encoder, which corresponds to a UE associated with the particular vendor, and at least one other encoder corresponding to at least one other UE associated with at least one other vendor of the set of vendors.

In a ninth aspect, alone or in combination with one or more of the first through eighth aspects, the encoder is associated with channel state feedback compression.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a second server, in accordance with the present disclosure. Example process 700 is an example where the second server (e.g., AP server 190) performs operations associated with offline multi-vendor training for cross-node machine learning.

As shown in FIG. 7, in some aspects, process 700 may include receiving, from a plurality of first servers associated with a plurality of encoders and a set of vendors, encoder training data regarding the plurality of encoders, wherein the second server is associated with a particular vendor of the set of vendors (block 710). For example, the second server (e.g., using communication manager 192 and/or reception component 802, depicted in FIG. 8) may receive, from a plurality of first servers associated with a plurality of encoders and a set of vendors, encoder training data regarding the plurality of encoders, wherein the second server is associated with a particular vendor of the set of vendors, as described above.

As further shown in FIG. 7, in some aspects, process 700 may include transmitting, to the plurality of first servers and based at least in part on receiving the encoder training data, decoder training data, of a decoder, associated with a configuration of the plurality of encoders (block 720). For example, the second server (e.g., using communication manager 192 and/or transmission component 804, depicted in FIG. 8) may transmit, to the plurality of first servers and based at least in part on receiving the encoder training data, decoder training data, of a decoder, associated with a configuration of the plurality of encoders, as described above.

Process 700 may include additional aspects, such as any single aspect or any combination of aspects described below and/or in connection with one or more other processes described elsewhere herein.

In a first aspect, the encoder training data includes at least one of ground truth data, activation data, or gradient data.

In a second aspect, alone or in combination with the first aspect, the decoder training data includes gradient data.

In a third aspect, alone or in combination with one or more of the first and second aspects, process 700 includes training the decoder using the encoder training data, and transmitting the decoder training data comprises transmitting information identifying one or more outputs from the training of the decoder.

In a fourth aspect, alone or in combination with one or more of the first through third aspects, process 700 includes determining a loss function associated with the decoder based at least in part on the encoder training data, and transmitting the decoder training data comprises transmitting one or more outputs from determining the loss function associated with the decoder.

In a fifth aspect, alone or in combination with one or more of the first through fourth aspects, process 700 includes deploying the decoder to at least one access point associated with the particular vendor.

In a sixth aspect, alone or in combination with one or more of the first through fifth aspects, the at least one access point, to which the decoder is deployed, is associated with at least one UE, associated with the particular vendor, to which an encoder, of the plurality of encoders, is deployed.

In a seventh aspect, alone or in combination with one or more of the first through sixth aspects, other encoders, of the plurality of encoders, are deployed to one or more other UEs associated with one or more other access points, to which one or more other decoders, trained by one or more other second servers, are deployed, wherein the one or more other access points and the one or more other UEs are associated with one or more vendors, other than the particular vendor, of the set of vendors.

In an eighth aspect, alone or in combination with one or more of the first through seventh aspects, the decoder is a single global decoder corresponding to the plurality of encoders and the set of vendors, wherein the plurality of encoders includes a first encoder, which corresponds to a UE and the second vendor, and at least one second encoder corresponding to at least one other UE and to at least one vendor, other than the particular vendor, of the set of vendors.

In a ninth aspect, alone or in combination with one or more of the first through eighth aspects, the decoder is associated with channel state feedback decompression or reconstruction.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a server, or a server may include the apparatus 800. For example, the apparatus 800 may be a first server (e.g., a UE server 180) and an apparatus 806 may be a second server (e.g., an AP server 190) or a UE (e.g., a UE 120). Additionally, or alternatively, the apparatus 800 may be a second server (e.g., AP server 190) and the apparatus 806 may be the first server (e.g., the UE server 180) or a network node (e.g., a network node 110).

In some aspects, the apparatus 800 includes a reception component 802 and a transmission component 804, which may be in communication with one another (for example, via one or more buses and/or one or more other components). As shown, the apparatus 800 may communicate with another apparatus 806 (such as another server, a UE, a base station, or another wireless communication device) using the reception component 802 and the transmission component 804. As further shown, the apparatus 800 may include the communication manager 182 or 192. The communication manager 182/192 may include one or more of a machine learning training component 808, a deployment component 810, or a determination component 812, among other examples.

In some aspects, the apparatus 800 may be configured to perform one or more operations described herein in connection with FIGS. 5A-5D. Additionally, or alternatively, the apparatus 800 may be configured to perform one or more processes described herein, such as process 600 of FIG. 6, process 700 of FIG. 7, or a combination thereof. In some aspects, the apparatus 800 and/or one or more components shown in FIG. 8 may include one or more components of the server described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the server described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the server described in connection with FIG. 2. In some aspects, the transmission component 804 may be co-located with the reception component 802 in a transceiver.

The transmission component 804 may transmit encoder training data regarding an encoder to a set of second servers associated with training a set of decoders and with a set of vendors, wherein the first server is associated with a particular vendor of the set of vendors. The reception component 802 may receive, from the set of second servers and based at least in part on transmitting the encoder training data, decoder training data associated with a configuration of the encoder.

The machine learning training component 808 may train the encoder using a training set for the encoder. The machine learning training component 808 may train the encoder using the decoder training data. The deployment component 810 may deploy the encoder to at least one UE associated with the particular vendor.

The reception component 802 may receive, from a plurality of first servers associated with a plurality of encoders and a set of vendors, encoder training data regarding the plurality of encoders, wherein the second server is associated with a particular vendor of the set of vendors. The transmission component 804 may transmit, to the plurality of first servers and based at least in part on receiving the encoder training data, decoder training data, of a decoder, associated with a configuration of the plurality of encoders.

The machine learning training component 808 may train the decoder using the encoder training data. The determination component 812 may determine a loss function associated with the decoder based at least in part on the encoder training data. The deployment component 810 may deploy the decoder to at least one access point associated with the particular vendor.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

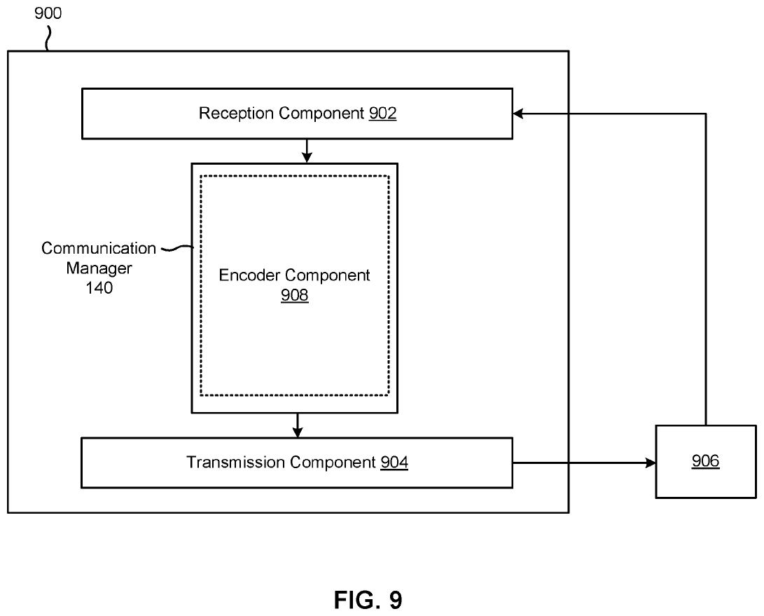

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include an encoder component 908, among other examples.

In some aspects, the apparatus 900 may be configured to perform one or more operations described herein in connection with FIGS. 5A-5D. Additionally, or alternatively, the apparatus 900 may be configured to perform one or more processes described herein. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive an encoder for use by the encoder component 908. The reception component 902 may receive one or more signals from which to generate CSF. The encoder component 908 may encode CSF for transmission to the apparatus 906. The transmission component 904 may transmit the encoded CSF to the apparatus 906.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

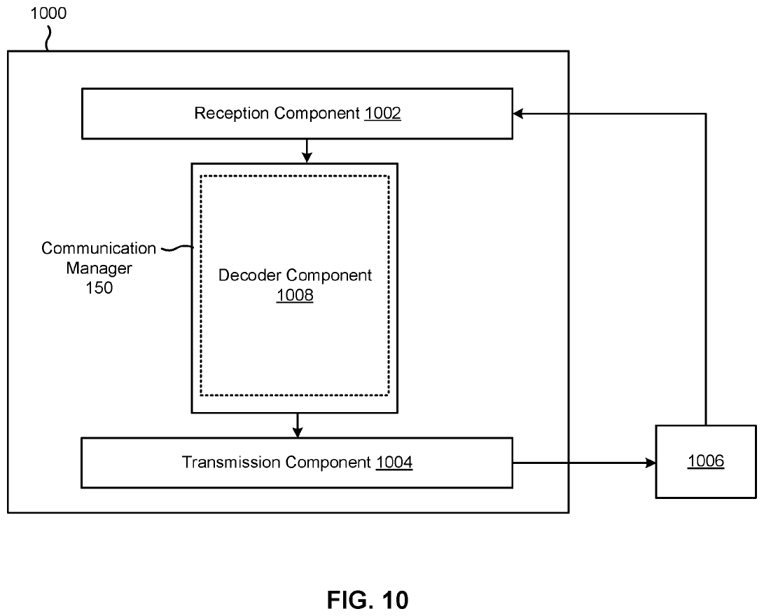

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include a decoder component 1008, among other examples.

In some aspects, the apparatus 1000 may be configured to perform one or more operations described herein in connection with FIGS. 5A-5D. Additionally, or alternatively, the apparatus 1000 may be configured to perform one or more processes described herein. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The reception component 1002 may receive a decoder for use by the decoder component 1008. The reception component 1002 may receive encoded CSF from the apparatus 1006. The decoder component 1008 may decode CSF. The transmission component 1004 may transmit one or more communications using a communication associated with the CSF and/or communication configuration information to set a communication configuration of the apparatus 1006 in accordance with the CSF.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

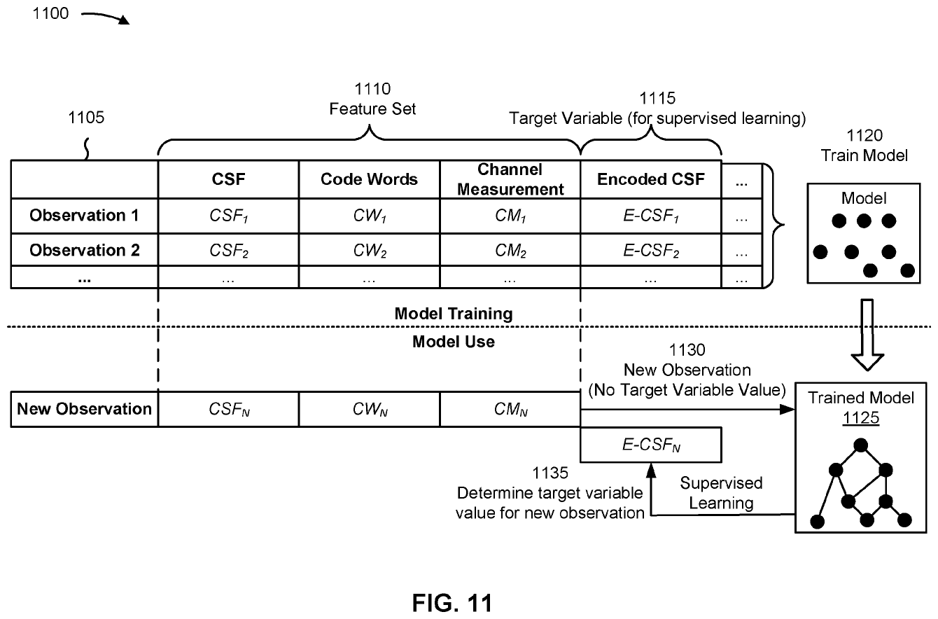

FIG. 11 is a diagram illustrating an example 1100 of training and using a machine learning model in connection with offline multi-vendor training for cross-node machine learning. The machine learning model training and usage described herein may be performed using a machine learning system. The machine learning system may include or may be included in a computing device, a server, a cloud computing environment, or the like, such as the first server (e.g., the UE server 180) or the second server (e.g., the AP server 190), described in more detail elsewhere herein.

As shown by reference number 1105, a machine learning model may be trained using a set of observations. The set of observations may be obtained from training data (e.g., historical data), such as data gathered during one or more processes described herein. In some implementations, the machine learning system may receive the set of observations (e.g., as input) from a UE 120 or a network node 110, as described elsewhere herein.

As shown by reference number 1110, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the UE 120 or the network node 110. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of CSF, a second feature of code words, a third feature of a channel measurement, and so on. As shown, for a first observation, the first feature may have a value of CSF₁, the second feature may have a value of CW₁, the third feature may have a value of CM₁, and so on. These features and feature values are provided as examples, and may differ in other examples.

As shown by reference number 1115, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 1100, the target variable is encoded CSF, which has a value of E-CSF₁ for the first observation.

The feature set and target variable described above are provided as examples, and other examples may differ from what is described above. For example, for a target variable of decoded CSF, the feature set may include encoded CSF.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 1120, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 1125 to be used to analyze new observations.

As an example, the machine learning system may obtain training data for the set of observations from a plurality of second servers associated with a plurality of vendors and may train an encoder for a particular vendor based at least in part on, for example, gradient data output from training decoder models for use by network nodes 110 associated with the plurality of vendors.

As shown by reference number 1130, the machine learning system may apply the trained machine learning model 1125 to a new observation, such as by receiving a new observation and inputting the new observation to the trained machine learning model 1125. As shown, the new observation may include a first feature of CSF_{N}, a second feature of CW_{N}, a third feature of CM_{N}, and so on, as an example. The machine learning system may apply the trained machine learning model 1125 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 1125 may predict a value of E-CSF_{N} for the target variable of encoded CSF for the new observation, as shown by reference number 1135. Based on this prediction, the machine learning system may provide a first recommendation, may provide output for determination of a first recommendation, may perform a first automated action, and/or may cause a first automated action to be performed (e.g., by instructing another device to perform the automated action), among other examples.

In some implementations, the trained machine learning model 1125 may be re-trained using feedback information. For example, feedback may be provided to the machine learning model. The feedback may be associated with actions performed based on the recommendations provided by the trained machine learning model 1125 and/or automated actions performed, or caused, by the trained machine learning model 1125. In other words, the recommendations and/or actions output by the trained machine learning model 1125 may be used as inputs to re-train the machine learning model (e.g., a feedback loop may be used to train and/or update the machine learning model). For example, the feedback information may include outputs of training a decoder model (when training an encoder model, and the feedback information may include outputs of training the encoder model when training a decoder model).

In this way, the machine learning system may apply a rigorous and automated process to generating an encoder or a decoder. The machine learning system enables recognition and/or identification of tens, hundreds, thousands, or millions of features and/or feature values for tens, hundreds, thousands, or millions of observations across a plurality of vendors, thereby increasing accuracy and consistency and reducing delay associated with generating an encoder or decoder relative to obtaining the observations from a single vendor.

As indicated above, FIG. 11 is provided as an example. Other examples may differ from what is described in connection with FIG. 11.

The following provides an overview of some Aspects of the present disclosure:

Aspect 1: A method of wireless communication performed by a first server, comprising: transmitting encoder training data regarding an encoder to a set of second servers associated with training a set of decoders and with a set of vendors, wherein the first server is associated with a particular vendor of the set of vendors; and receiving, from the set of second servers and based at least in part on transmitting the encoder training data, decoder training data associated with a configuration of the encoder.

Aspect 2: The method of Aspect 1, wherein the encoder training data includes at least one of: ground truth data, activation data, or gradient data.

Aspect 3: The method of any of Aspects 1 to 2, wherein the decoder training data includes gradient data.

Aspect 4: The method of any of Aspects 1 to 3, further comprising: training the encoder using a training set for the encoder; and wherein transmitting the encoder training data comprises: transmitting information identifying one or more outputs from the training of the encoder.

Aspect 5: The method of any of Aspects 1 to 4, further comprising: training the encoder using the decoder training data.

Aspect 6: The method of any of Aspects 1 to 5, further comprising: deploying the encoder to at least one user equipment (UE) associated with the particular vendor.

Aspect 7: The method of Aspect 6, wherein the at least one UE, to which the encoder is deployed, is associated with at least one access point, associated with the particular vendor, to which a decoder, of the set of decoders, is deployed.

Aspect 8: The method of Aspect 7, wherein other decoders, of the set of decoders, are deployed to one or more other access points associated with one or more other UEs, to which other encoders, trained by one or more other first servers, are deployed, wherein the one or more other access points and the one or more other UEs are associated with one or more vendors, other than the particular vendor, of the set of vendors.

Aspect 9: The method of Aspect 6, wherein the set of decoders includes a single global decoder corresponding to a plurality of encoders and associated with the set of vendors, wherein the plurality of encoders includes the encoder, which corresponds to a UE associated with the particular vendor, and at least one other encoder corresponding to at least one other UE associated with at least one other vendor of the set of vendors.

Aspect 10: The method of any of Aspects 1 to 9, wherein the encoder is associated with channel state feedback compression.

Aspect 11: A method of wireless communication performed by a second server, comprising: receiving, from a plurality of first servers associated with a plurality of encoders and a set of vendors, encoder training data regarding the plurality of encoders, wherein the second server is associated with a particular vendor of the set of vendors; and transmitting, to the plurality of first servers and based at least in part on receiving the encoder training data, decoder training data, of a decoder, associated with a configuration of the plurality of encoders.

Aspect 12: The method of Aspect 11, wherein the encoder training data includes at least one of: ground truth data, activation data, or gradient data.

Aspect 13: The method of any of Aspects 11 to 12, wherein the decoder training data includes gradient data.

Aspect 14: The method of any of Aspects 11 to 13, further comprising: training the decoder using the encoder training data; and wherein transmitting the decoder training data comprises: transmitting information identifying one or more outputs from the training of the decoder.

Aspect 15: The method of any of Aspects 11 to 14, further comprising: determining a loss function associated with the decoder based at least in part on the encoder training data; and wherein transmitting the decoder training data comprises: transmitting one or more outputs from determining the loss function associated with the decoder.

Aspect 16: The method of any of Aspects 11 to 15, further comprising: deploying the decoder to at least one access point associated with the particular vendor.

Aspect 17: The method of Aspect 16, wherein the at least one access point, to which the decoder is deployed, is associated with at least one user equipment (UE), associated with the particular vendor, to which an encoder, of the plurality of encoders, is deployed.

Aspect 18: The method of Aspect 17, wherein other encoders, of the plurality of encoders, are deployed to one or more other UEs associated with one or more other access points, to which one or more other decoders, trained by one or more other second servers, are deployed, wherein the one or more other access points and the one or more other UEs are associated with one or more vendors, other than the particular vendor, of the set of vendors.

Aspect 19: The method of Aspect 16, wherein the decoder is a single global decoder corresponding to the plurality of encoders and the set of vendors, wherein the plurality of encoders includes a first encoder, which corresponds to a user equipment (UE) and the second vendor, and at least one second encoder corresponding to at least one other UE and to at least one vendor, other than the particular vendor, of the set of vendors.

Aspect 20: The method of any of Aspects 11 to 19, wherein the decoder is associated with channel state feedback decompression or reconstruction.

Aspect 21: An apparatus for wireless communication at a device, comprising a processor; memory coupled with the processor; and instructions stored in the memory and executable by the processor to cause the apparatus to perform the method of one or more of Aspects 1-10.

Aspect 22: A device for wireless communication, comprising a memory and one or more processors coupled to the memory, the one or more processors configured to perform the method of one or more of Aspects 1-10.

Aspect 23: An apparatus for wireless communication, comprising at least one means for performing the method of one or more of Aspects 1-10.

Aspect 24: A non-transitory computer-readable medium storing code for wireless communication, the code comprising instructions executable by a processor to perform the method of one or more of Aspects 1-10.

Aspect 25: A non-transitory computer-readable medium storing a set of instructions for wireless communication, the set of instructions comprising one or more instructions that, when executed by one or more processors of a device, cause the device to perform the method of one or more of Aspects 1-10.

Aspect 26: An apparatus for wireless communication at a device, comprising a processor; memory coupled with the processor; and instructions stored in the memory and executable by the processor to cause the apparatus to perform the method of one or more of Aspects 11-20.

Aspect 27: A device for wireless communication, comprising a memory and one or more processors coupled to the memory, the one or more processors configured to perform the method of one or more of Aspects 11-20.

Aspect 28: An apparatus for wireless communication, comprising at least one means for performing the method of one or more of Aspects 11-20.

Aspect 29: A non-transitory computer-readable medium storing code for wireless communication, the code comprising instructions executable by a processor to perform the method of one or more of Aspects 11-20.

Aspect 25: A non-transitory computer-readable medium storing a set of instructions for wireless communication, the set of instructions comprising one or more instructions that, when executed by one or more processors of a device, cause the device to perform the method of one or more of Aspects 11-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first server, comprising:
a memory; and
one or more processors, coupled to the memory, configured to:
transmit encoder training data regarding an encoder to a set of second servers associated with training a set of decoders and with a set of vendors, wherein the first server is associated with a particular vendor of the set of vendors; and
receive, from the set of second servers and based at least in part on transmitting the encoder training data, decoder training data associated with a configuration of the encoder.

2. The first server of claim 1, wherein the encoder training data includes at least one of:
ground truth data,
activation data, or
gradient data.

3. The first server of claim 1, wherein the decoder training data includes gradient data.

4. The first server of claim 1, wherein the one or more processors are further configured to:
train the encoder using a training set for the encoder; and
wherein the one or more processors, to transmit the encoder training data, are configured to:
transmit information identifying one or more outputs from the training of the encoder.

5. The first server of claim 1, wherein the one or more processors are further configured to:
train the encoder using the decoder training data.

6. The first server of claim 1, wherein the one or more processors are further configured to:
deploy the encoder to at least one user equipment (UE) associated with the particular vendor.

7. The first server of claim 6, wherein the at least one UE, to which the encoder is deployed, is associated with at least one access point, associated with the particular vendor, to which a decoder, of the set of decoders, is deployed.

8. The first server of claim 7, wherein other decoders, of the set of decoders, are deployed to one or more other access points associated with one or more other UEs, to which other encoders, trained by one or more other first servers, are deployed, wherein the one or more other access points and the one or more other UEs are associated with one or more vendors, other than the particular vendor, of the set of vendors.

9. The first server of claim 6, wherein the set of decoders includes a single global decoder corresponding to a plurality of encoders and associated with the set of vendors, wherein the plurality of encoders includes the encoder, which corresponds to a UE associated with the particular vendor, and at least one other encoder corresponding to at least one other UE associated with at least one other vendor of the set of vendors.

10. The first server of claim 1, wherein the encoder is associated with channel state feedback compression.

11. A second server, comprising:
a memory; and
one or more processors, coupled to the memory, configured to:
receive, from a plurality of first servers associated with a plurality of encoders and a set of vendors, encoder training data regarding the plurality of encoders, wherein the second server is associated with a particular vendor of the set of vendors; and
transmit, to the plurality of first servers and based at least in part on receiving the encoder training data, decoder training data, of a decoder, associated with a configuration of the plurality of encoders.

12. The second server of claim 11, wherein the encoder training data includes at least one of:
ground truth data,
activation data, or
gradient data.

13. The second server of claim 11, wherein the decoder training data includes gradient data.

14. The second server of claim 11, wherein the one or more processors are further configured to:
train the decoder using the encoder training data; and
wherein the one or more processors, to transmit the decoder training data, are configured to:
transmit information identifying one or more outputs from the training of the decoder.

15. The second server of claim 11, wherein the one or more processors are further configured to:
determine a loss function associated with the decoder based at least in part on the encoder training data; and
wherein the one or more processors, to transmit the decoder training data, are configured to:
transmit one or more outputs from determining the loss function associated with the decoder.

16. The second server of claim 11, wherein the one or more processors are further configured to:
deploy the decoder to at least one access point associated with the particular vendor.

17. The second server of claim 16, wherein the at least one access point, to which the decoder is deployed, is associated with at least one user equipment (UE), associated with the particular vendor, to which an encoder, of the plurality of encoders, is deployed.

18. The second server of claim 17, wherein other encoders, of the plurality of encoders, are deployed to one or more other UEs associated with one or more other access points, to which one or more other decoders, trained by one or more other second servers, are deployed, wherein the one or more other access points and the one or more other UEs are associated with one or more vendors, other than the particular vendor, of the set of vendors.

19. The second server of claim 16, wherein the decoder is a single global decoder corresponding to the plurality of encoders and the set of vendors, wherein the plurality of encoders includes a first encoder, which corresponds to a user equipment (UE) and the particular vendor, and at least one second encoder corresponding to at least one other UE and to at least one vendor, other than the particular vendor, of the set of vendors.

20. The second server of claim 11, wherein the decoder is associated with channel state feedback decompression or reconstruction.

21. A method performed by a first server, comprising:
transmitting encoder training data regarding an encoder to a set of second servers associated with training a set of decoders and with a set of vendors, wherein the first server is associated with a particular vendor of the set of vendors; and
receiving, from the set of second servers and based at least in part on transmitting the encoder training data, decoder training data associated with a configuration of the encoder.

22. The method of claim 21, wherein the encoder training data includes at least one of:
ground truth data,
activation data, or
gradient data.

23. The method of claim 21, the decoder training data includes gradient data.

24. The method of claim 21, further comprising:
training the encoder using a training set for the encoder; and
wherein transmitting the encoder training data comprises:
transmitting information identifying one or more outputs from the training of the encoder.

25. The method of claim 21, further comprising:
training the encoder using the decoder training data.

26. The method of claim 21, further comprising:
deploying the encoder to at least one user equipment (UE) associated with the particular vendor.

27. A method performed by a second server, comprising:
receiving, from a plurality of first servers associated with a plurality of encoders and a set of vendors, encoder training data regarding the plurality of encoders, wherein the second server is associated with a particular vendor of the set of vendors; and
transmitting, to the plurality of first servers and based at least in part on receiving the encoder training data, decoder training data, of a decoder, associated with a configuration of the plurality of encoders.

28. The method of claim 27, wherein the encoder training data includes at least one of:
ground truth data,
activation data, or
gradient data.

29. The method of claim 27, wherein the decoder training data includes gradient data.

30. The method of claim 27, further comprising:
training the decoder using the encoder training data; and
wherein transmitting the decoder training data comprises:
transmitting information identifying one or more outputs from the training of the decoder.
